(19) United States
(12) Patent Application Publication
(10) Pub. No.: US 2007/0203745 A1
(43) Pub. Date: Aug. 30, 2007

(54) Method for resolving workflow conflicts of multiple connected information systems to a central data management system

(76) Inventors: Ernst Bartsch, Nurnberg (DE); Martin Lang, Erlangen (DE); Karol Ruckschloss, Erlangen (DE)

Correspondence Address: SCHIFF HARDIN LLP;Patent Department, 6600 Sears Tower, 233 South Wacker Drive, Chicago, IL, 60606, US

(21) Appl. No.: 11/364,603

(22) Filed: Feb. 28, 2006

(51) Int. Cl. G06Q 10/00; G06Q 50/00

(52) U.S. Cl. 705/2; 705/80

(57) ABSTRACT

In a healthcare data management system having autonomous information systems for scheduling procedures on imaging modalities via a central data management system, a conflict resolution method is provided. Logic for identifying conflicting messages is provided at the data management system by comparing key information in data fields. Upon identifying a conflict, conflict resolution information is transmitted back to one of the conflicting information systems via back channel. In a preferred embodiment, a proposed new value for the conflicting data field is provided by the data management logic. The information system may either accept the recommended value or generate a new value. Loss of information in the conflicting messages is thereby avoided.

### BACKGROUND OF THE INVENTION

1. Field of the Invention

The present invention relates generally to a method for resolving workflow conflicts among multiple connected information systems, and in particular to a method for resolving workflow conflicts between information systems of a healthcare enterprise connected to a central data management system.

2. Description of the Related Art

Healthcare systems have begun to utilize a standardized communication protocol referred to as DICOM (digital imaging and communication in medicine). Using the DICOM standard, systems such as magnetic resonance imaging systems, computer tomography imaging systems, cardiology information systems, radiology information systems, pathology information systems and the like may communicate with one another using IHE (integrated healthcare enterprise) compliant messages. Centralized storage and management information and data is performed by servers operating under the PACS (picture archiving and communication system) standard. The individual information systems, such as the magnetic resonance system or computer tomography system are referred to according to the DICOM standard as modalities.

When connecting multiple information systems like radiology information system, cardiology information system, pathology information systems and the like to one enterprise wide image data management system, workflow conflicts can arise. This is assuming that all of the information systems are communicating according to the IHE compliant protocols.

The information systems create examination schedules that are communicated to the enterprise wide data management system which includes a PACS server. The examination schedules are also communicated to the imaging modalities such as the magnetic resonance imaging modality and the computer tomography modality. The individual information systems typically are not aware of the existence of other systems to which they are connected. If all of the information systems use a sequence of numbers for certain keys for examination, this can lead to conflicts which makes it impossible to match scheduled examinations to the images from the modality.

When more than one information system uses the same value for a certain key, this creates an inconsistency on the PACS server. The inconsistency causes the transaction to be rejected. The user is often not even notified about the problem and only later finds out when the expected data is not visible in the clinical workflow.

Finding an agreement between a set of autonomous actors is a problem addressed in the research domain of distributed algorithms. The problem is referred to as the “consensus problem” in the technical literature. Formally, the consensus problem can be described by the following scenario. A set of n (equal) processes p₁ through pₙ want to form an agreement on a common value. Every process proposes a value v once using an operation propose(v). Processes should decide a value once using an operation 2decide(v). The proposed and decided values are 0 or 1, in this simplified example. An example of a solution of the consensus problem is the 2-phase and the 3-phase commit protocols.

### SUMMARY OF THE INVENTION

A method for automatically detecting workflow conflicts and resolving those workflow conflicts is provided. The workflow conflict detection and resolution forms part of an enterprise wide image data management system. Specifically, the present invention provides a back channel for communication between a central server and each of the information systems connected to the data management system. The back channel transports conflict resolution messages from the server to the respective information system.

### BRIEF DESCRIPTION OF THE DRAWINGS

FIG. 1 is a schematic representation of a healthcare data system including several information systems and imaging modalities connected to a central data management system;

FIG. 2 is a schematic diagram of an information system connected to a central data management system by a communication channel and by a conflict resolution information channel according to the principles of the present invention;

FIG. 3 is a schematic representation of message transmission in a healthcare system according to one aspect of the present invention; and

FIG. 4 is a functional block diagram of workflow conflict resolution according to the present method.

### DETAILED DESCRIPTION OF THE PREFERRED EMBODIMENTS

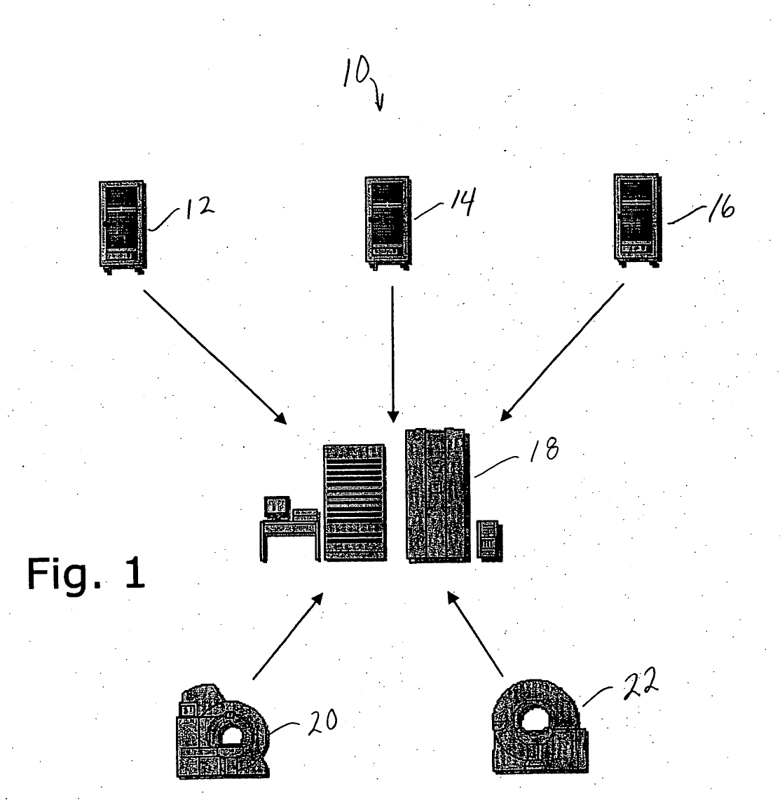

Referring first to FIG. 1, a healthcare system 10 includes a number of information systems such as a radiology information system 12, a cardiology information system 14, and a pulminology system 16. These information systems 12, 14 and 16, as well as potentially others, are connected to a central or enterprise wide data management system 18 which operates, according to a preferred embodiment, u sing the PACS (picture archiving and communication system) standard. The PACS standard is provided under the DICOM (digital imaging and communication in medicine) protocol. The various information systems 12, 14 and 16 may schedule diagnostic imaging and review the results of the diagnostic imaging which are stored on the enterprise wide data management system 18. In order to obtain the images, various imaging modalities are provided including, in this example, a magnetic resonance modality 20 at a computer tomography modality 22.

In one example, the radiology department in the healthcare facility has a patient that needs a computer tomography image obtained for diagnosis of a condition, and so the radiology department uses the radiology information system 12 to set up the computer tomography examination. The computer tomography examination is scheduled through the PACS server 18 to assign a time on the computer tomography modality 22 for the patient's examination. Other departments are likewise scheduling their patients for examination procedures as well, each through their respective department information systems. The cardiology information therefore schedules an examination for one of it's patients on the computer tomography modality 22 by sending an examination schedule message.

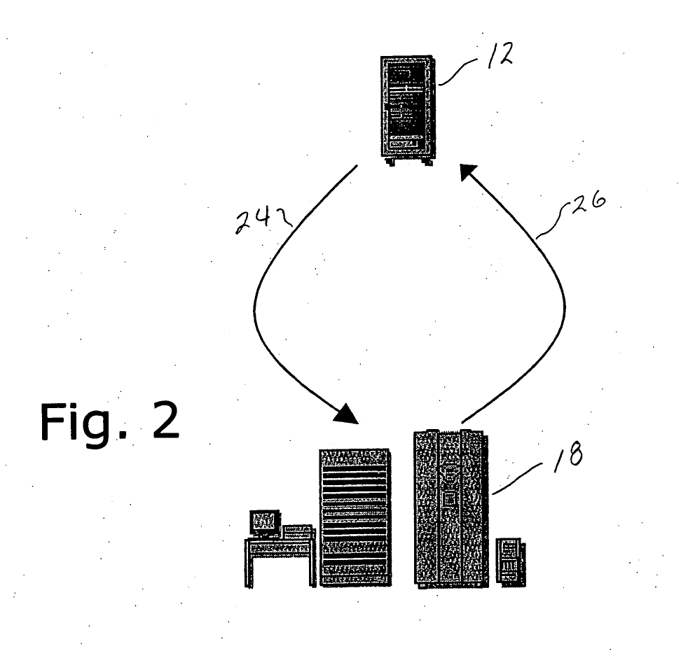

As noted in the foregoing, the information systems 12, 14 and 16 create examination schedules by sending messages that include sequence numbers as a component of the data. Two or more of the information systems may create examination schedules using the same sequence number, which results in a conflict in the system between these two scheduled examinations. As shown in FIG. 2, an information system, here indicated as the radiology information system 12, has a communication channel 24 for communicating schedules, updates, reports and the like to the central data management system 18. A second communication channel 26 is provided between the information system and the PACS server 18 as a back channel for transmitting conflict resolution information.

When a message is received from the information system 12 via the communication channel 24 that presents a conflict or potential conflict, a conflict resolution message is sent to the information system 12 via the second channel 26. A conflict resolution message that is sent to the information system 12 by the server 18 includes the reason why the message could not be processed. Along with the reason, instructions are also provided for generating a new value for a given key. Specifically, the conflict resolution message indicates which key caused the problem and proposes a new value for the key which allow processing of the given transaction. The information system 12 then generates a new value for the conflicting key and resends the message that was discarded by the central PACS server. If the PACS server instead proposes a. new value for the key, the information server 12 can accept this value or may generate a new one.

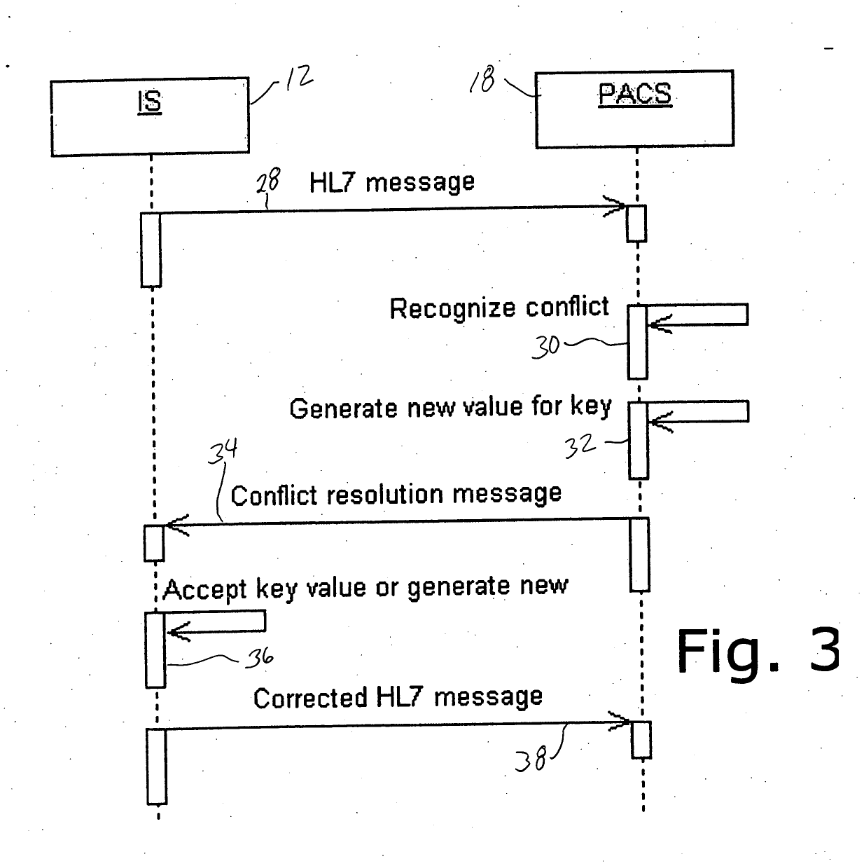

An example of a conflict resolution is illustrated in FIG. 3. The information system 12 transmits a message 28 to the PACS server 18. The message of a preferred embodiment is a standardized message such as a message compliant with the HL7 (health level 7) formatting in protocol standard. The PACS server 18 recognizes the conflict at 30 and generates a new value for the key which resulted in the conflict at 32 and thereafter forwards a conflict resolution message 34 from the PACS server 18 to the information system 12. The information system 12 accepts the key value or generates a new key value at 36. This results in the information system 12 generating and transmitting a corrected HL 7 message (for example) at 38.

A workflow conflict can be recognized by one of the following events: A consistency check may be performed by storing the values that would create an inconsistent state of the data storage and checking as between the stored values and the incoming values. On the other hand, a database exception may occur during committing of the data base transaction, caused by a unique index constraint or some other restriction on the data fields. According to the present invention, logic means are provided at the PACS server 18 as a way of generating a new value for the conflicting key. The system that generates the new value has to guarantee that this new value for the key will be unique throughout the enterprise wide image data management system. For example, a new ID (identity) for an accession number may be generated by concatenating a unique key prefix “ACC” (for accession number) with the current system date time in milliseconds. In one example, this would result in the accession number “ACC1127821484014” if the time and date is Tuesday Sep. 27, 2005 at 13:44:44 cest. Similar mechanisms may be applied to other keys in the communications such as the Study Instance UID (unique identifier) the Patient ID, the visit number, the SPS ID (schedule procedure step identification) and so on.

According to a preferred embodiment, the information system also includes logic for acceptance of the proposed key. The logic at the information system 12 verifies that the proposed key is unique in the information system. If the key is unique, the logic initiates a resending of the HL7 transaction message with the accepted key. If the key is not unique to the information system and is rejected, the information system generates a new value and resends the HL7 transaction with a new information system generated key value.

The foregoing description uses the radiology information system 12 as an example. The concepts described herein apply to any information system connected to the server.

Other advantages and features of the present invention may become more apparent by a review of the example set forth. hereinafter.

A medical center, hospital or other medical care facility may utilize an enterprise wide image data management system for maintaining medical image data. Various information systems connected to the image data management system may generate conflicting requests as the result of identical key data in particular data fields. For instance, certain key fields are globally unique, such as the Study Instance UID (unique identification). Other fields in standard data protocol transmission are simply running numbers. An example is the Accession Number. By way of illustrating example, a radiological information system 12 at a healthcare facility creates an examination schedule for a magnetic resonance modality (magnetic resonance imaging system) 20 for a patient identified as “SmithˆJohn” and provides Accession Number “456” and Study Instance UID “1.2.3.45678.9012345”. Within the same healthcare facility, the cardiology information system 14 creates a schedule for another patient identified as “TaylorˆJane”, Accession Number “456” and Study Instance UID 1.5.7.91357.9135791.” Both examinations schedule are sent to the central PACS server 18. Now the problem arises. The PACS server 18 cannot tell to which examination the Accession Number “456” belongs. Does this Accession Number belong to the patient “SmithˆJohn” (John Smith) or the patient “TaylorˆJane” (Jane Taylor)?

Usually such a conflict is handled by discarding the second schedule item which references an existing Accession Number for another patient. In this instance, the cardiology work for the patient Jane Taylor would be deleted from the server. This means that the second schedule item would not be available in the clinical workflow and the user (the cardiology unit) would not even be notified of the cancellation.

According to the present invention, the PACS server 18 proposes a new value for the Accession Number after it recognizes a conflict in this number. The PACS server 18 sends a conflict resolution message to the cardiology information system to inform the cardiology information system that the original schedule item for the patient “TaylorˆJane” has been discarded. In the same message, the PACS server 18 proposes a new value for the Accession Number, here the value “CR456-54”. The PACS server 18 can guarantee that at this moment the proposed value is unique and can be used.

After the cardiology information system 12 receives the conflict resolution message containing the proposed new Accession Number CR456-54, the cardiology information system can send a new scheduled item with the following values: “TaylorˆJane”, Accession Number “CR456-54” and Study Instance UID “1.5.7.91357.9135791”. The PACS server 18 then processes this new message because the given key values do not produce a conflict with the existing data stored in the PACS data base.

The foregoing example of the conflict in the Accession Number data is only one example of the type conflicts which can occur and the type of conflicts which can be resolved by the present system. In particular, an analogous approach can be used for all other keys. For example, conflicts in Patient ID, Study Instances UID, Visit Identifier, and Scheduled Procedure Step ID may be resolved according to the present method.

A conceptual difference between the consensus problem and the present method is the result of the heterogeneous participants in the present system being set in a current healthcare infrastructure. Typically, the -ology-information systems have a different and restricted functional range, for example with respect to the capability to adapt identification. The informations systems also have their own local identity management, which is usually not directly accessible by an outside application. This leads to a different, heterogeneous setting where the participants are not always able to adapt their local identity management data base. It is thus necessary to provide a dedicated component for the compensation of conflicts caused by the restricted identify management capabilities of the participating -ology-information systems.

Thus, the present method provides an automated resolution of typical conflicts in a scenario where multiple autonomous information systems communicate with a central PACS server. The resolution does not require assistance from or participation by an administrator or user.

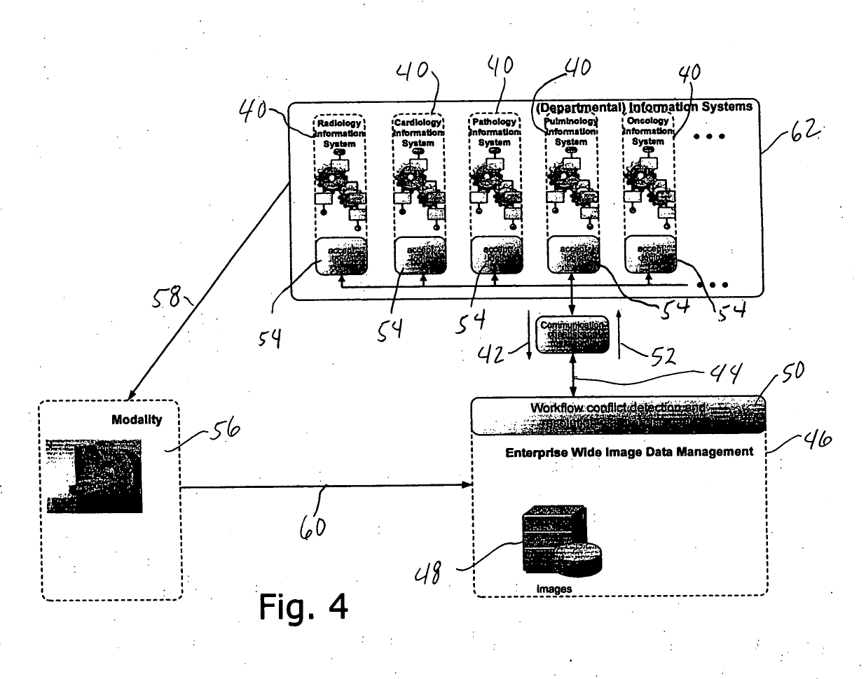

Additional details are apparent from FIG. 4. Acceptance logic, also termed accept logic, 54 is provided for each of the information systems, here indicated as 40. After receiving a conflict resolution message 52 from the enterprise image data management server 46, for example, the PACS server, the accept logic 54 is triggered at the departmental information system 40 and the information system 40 may either accept the proposed value or generate a new one. A communication channel 44 is provided which is described above. A workflow conflict detection and resolution method is also provided via the logic 50. At the enterprise image data management system 46 for example the PACS server, the workflow conflicts are detected and appropriate resolution mechanisms are triggered. In this instance, a conflict resolution message is sent.

The workflow diagram of FIG. 4 illustrates the overall concepts in different components which interact in resolving the workflow conflicts. For instance, the information systems which are here indicated as departmental information systems 40, indicated collectively at 62, provide the workflow information such as schedules, updates and reports 42 via a communication channel and messaging connection 44 to the enterprise wide image data management system 46. The enterprise wide image data management system 46 stores images 48 of the data received. But prior to storage, a workflow conflict detection and resolution logic 50 determines whether there is a conflict between incoming messages 42 from the information systems 40. Once a conflict is found, conflict resolution information 52 is provided via the communication and messaging channel 44 to the information systems 40. Each of the information systems 40 is provided with an accept logic 54 which receives the conflict resolution information 52. The communication and messaging channel 44 shown in FIG. 4 includes the primary communication pathway from the information systems 40 and also includes the backchannel pathway from the server 46 to the information systems 40. Communications according to FIG. 3 resolve the conflicts in the messages and establish the scheduling of the modalities. A modality is indicated at 56 which receives a modality work list 58 from the information systems 40 and then transmits the resulting images 60 to the image data management system 46.

Thus, there is provided a back channel communication between the PACS server and the information system. Further information systems 40 can be transparently added to the hospital or healthcare facility without requiring any identity pre-configuration of the information system. For example, without the present apparatus and method, a new information system added to the server may issue scheduling messages that are in conflict with the existing information system messages. Conflicts are resolved by the present system.

Thus, there is provided a conflict resolution method and apparatus in a healthcare data management system having autonomous information systems for scheduling procedures on imaging modalities via a central data management system. Logic for identifying conflicting messages is provided at the data management system by comparing key information in data fields. Upon identifying a conflict, conflict resolution information is transmitted back to one of the conflicting information systems via back channel. In a preferred embodiment, a proposed new value for the conflicting data field is provided by the data management logic. The information system may either accept the recommended value or generate a new value. Loss of information in the conflicting messages is thereby avoided.

Although other modifications and changes may be suggested by those skilled in the art, it is the intention of the inventors to embody within the patent warranted hereon all changes and modifications as reasonably and properly come within the scope of their contribution to the art.

We claim:

1. A method for conflict resolution in a healthcare data communication system having a plurality of information systems and a data management system, comprising the steps of:
providing a primary communication channel between. the information systems and a data management system, said primary information channel carrying examination schedule information from the information systems to the data management system;
providing a second communication channel between at least one of the information systems and said data management system via which communications are transmitted concerning conflicts between examination schedules received from the information systems; and
providing a communication and messaging logic operable to automatically detect and resolve workflow conflicts between messages received from the information systems.

2. A method as claimed in claim 1, wherein said communication and messaging logic is provided at the data management system.

3. A method as claimed in claim 1, further comprising the step of:
providing rules and logic at the data management system operable to generate non-conflicting key data for transmittal to corresponding ones of the information systems.

4. A method as claimed in claim 3, wherein said rules and logic are provided in said communication and messaging logic at the data management system.

5. A method as claimed in claim 1, further comprising the step of:
providing acceptance logic at each of the information systems operable to process conflict resolution information.

6. A method for resolving conflicts between messages received from ones of a plurality of information systems by a data management system, comprising the steps of:
receiving messages from at least two of said information systems at said data management system, said messages including fields having key data;
recognizing a conflict between at least two of said messages, said conflict being characterized by at least substantially identical data in at least one of said fields, said at least substantially identical data being conflicting data;
generating a new value for at least one of the conflicting data;
transmitting a conflict resolution message from said data management system to at least one of said corresponding information systems which were recognized as having provided conflicting messages; and
receiving a corrected message from said at least one information system.

7. A method as claimed in claim 6, further comprising: accepting a proposed key value of said conflict resolution message.

8. A method as claimed in claim 6, further comprising the step of:
generating a new key value upon receipt of said conflict resolution message.
